(19) United States
(12) Patent Application Publication
(10) Pub. No.: US 2013/0185569 A1
(43) Pub. Date: Jul. 18, 2013

(54) DATA PROTECTION SYSTEM AND METHOD BASED ON CLOUD STORAGE

(71) Applicant: Zhong-Lin XU, Shenzhen City (CN)

(72) Inventor: Zhong-Lin XU, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/422,162

(22) Filed: Mar. 16, 2012

(30) Foreign Application Priority Data
Jan. 12, 2012 (CN) 201210008181.3

(51) Int. Cl. G06F 21/24

(52) U.S. Cl. 713/189; 726/26

(57) ABSTRACT

A data protection system implemented by a data protection device divides original data of a user into a plurality of data packets, and allots a sequential number to each second data. The system encrypts each of the data packets in sequence according to the allotted number of each of the data packets. After each of the data packets has been encrypted, the system moves each encrypted data packet from the data protection device to a cloud storage device in communication with the data protection device through a network.

### BACKGROUND

1. Technical Field

Embodiments of the present disclosure relate generally to data security technologies, and particularly to a data protection system and method implemented by a data protection device based on cloud storage.

2. Description of Related Art

Cloud storage services are used by individuals and companies for storing important data. Whether individual or company, all are concerned about security and privacy of the data that is stored over the cloud storage services. For companies especially, incalculable losses may occur if important or confidential data is discovered or released. Moreover, it is possible that the vendor of the cloud storage services may access data stored over the cloud storage services, which increases the worries of users about the data security and privacy.

### BRIEF DESCRIPTION OF THE DRAWINGS

FIG. 1 is a schematic diagram illustrating one embodiment of a data protection device that communicates with at least one cloud storage device.

FIG. 2 is a schematic diagram illustrating one embodiment of the data protection device including functional modules of a data protection system of FIG. 1.

FIG. 3 is a flowchart of one embodiment of a data protection method that is implemented for storing data of a user into the cloud storage device.

FIG. 4 is a flowchart of one embodiment of the data protection method that is implemented for accessing the stored data from the cloud storage device.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

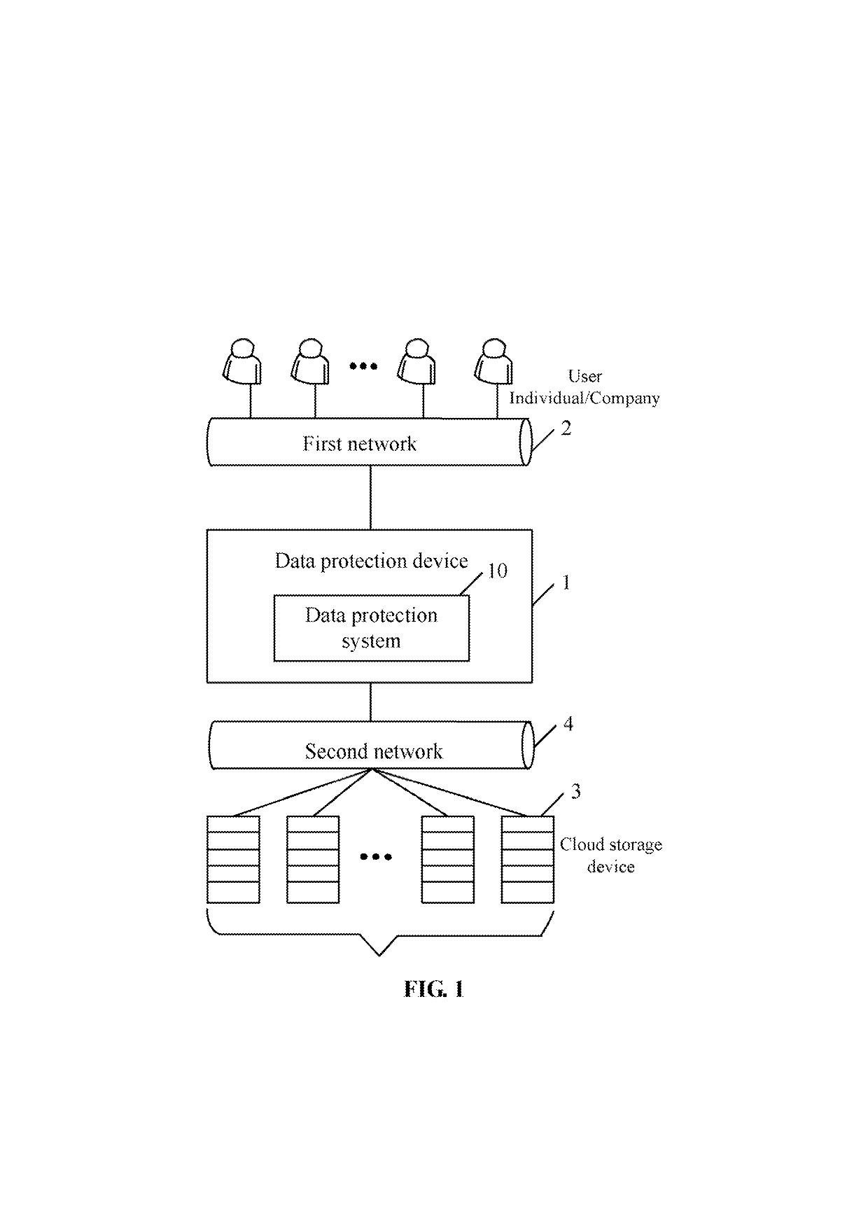

FIG. 1 is a schematic diagram illustrating one embodiment of a data protection device 1 that communicates with at least one cloud storage device 3. In one embodiment, a user such as an individual or a company can access the data protection device 1 through a first network 2 and request the storage of types of data in the cloud storage device 3, by means of the data protection device 1. The data protection device 1 processes the data from a user and transmits the processed data to the cloud storage device 3 through a second network 4 without storing any of the processed data in the data protection device 1. Details of processing the data are provided below. In the embodiment, the data protection device 1 and the cloud storage device 3 may respectively be, for example, a computer and a cloud server. Either the first network 2 or the second network 4 may be, for example, an electronic network or a wireless network. In one embodiment, the first network 2 may be the same type of network as the second network 4. In another embodiment, the first network 2 may be different from the second network 4. In addition, the data protection device 1 and the cloud storage device 3 are respectively provided by different vendors, so that neither the vendor of the data protection device 1 nor the vendor of the cloud storage device 3 has inherent access to the stored data, and require the authorization of the user.

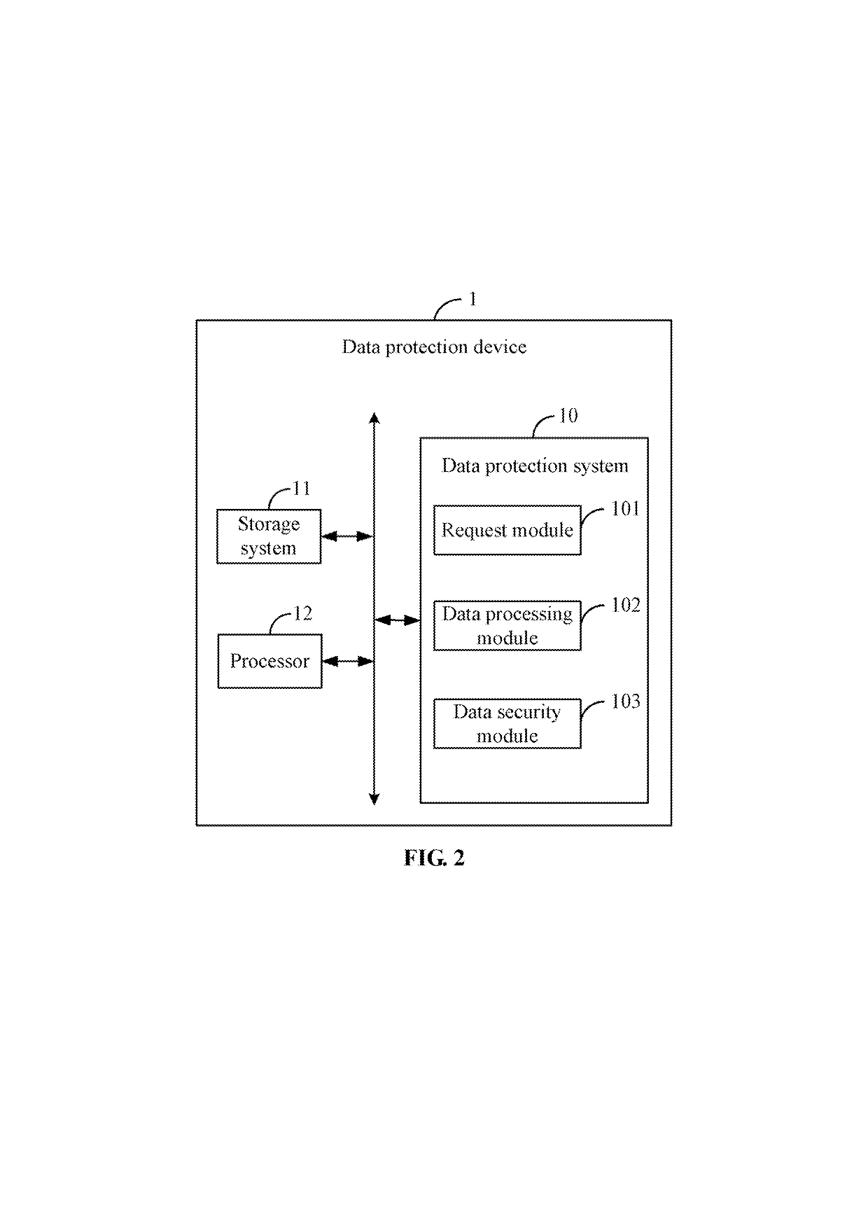

FIG. 2 is a schematic diagram illustrating one embodiment of the data protection device 1 comprising functional modules of a data protection system 10. In the embodiment, the data protection device 1 includes a storage system 11, a processor 12, and the data protection system 10. The storage system 11 stores one or more programs, such as an operating system, and applications of the data protection device 1.

In one embodiment, the storage system 11 may be a random access memory (RAM) for the temporary storage of information, and/or a read only memory (ROM) for the permanent storage of information. In other embodiments, the storage system 11 may also be an external storage device, such as a hard disk, a storage card, or other data storage medium. FIG. 2 is only one example of the data protection device 1, and the data protection device 1 can include more or fewer components than those shown in the embodiment, or have components in a different configuration.

The data protection system 10 may include a plurality of programs in the form of one or more computerized instructions stored in the storage system 11 and executed by the processor 12 to perform operations of the data protection device 1. In the embodiment, the data protection system 10 includes a request module 101, a data processing module 102, and a data security module 103. In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

The request module 101 receives a first request message from a user who requests to store first data, such as images, videos, some important documents, or other kind of relevant information of the user, in the cloud storage device 3, and receives the first data to be stored through the first network 2. In one embodiment, the user may login onto the protection device 1 using a client device (such as a personal computer of the user) through the first network 2, and then send the request message using the client device.

The data processing module 102 divides the received first data into a plurality of data packets (each separate data packets referred to hereinafter as contained within the generic expression “second data”) and allots a sequential number to each second data. In one embodiment, the data processing module 102 may divide the first data using a known mathematical algorithm, such as the information dispersal algorithm (IDA).

The data security module 103 encrypts each of the second data in sequence according to the allotted numbers of the second data, and moves the encrypted second data from the data protection device 1 to the cloud storage device 3 through the second network 4. In one embodiment, the data security module 103 may automatically encrypt the second data using a first data encryption algorithm. In other embodiments, the data security module 103 receives an encryption key from the user for encrypting the second data, and then encrypts the second data using a second data encryption algorithm according to the encryption key.

The first data is stored into the cloud storage device 3 after the second data has been moved to the cloud storage device 3. Since the first data stored in the cloud storage device 3 has been divided and encrypted by the data protection device 1, the security and privacy of the first data can be better ensured. The user can request access to the data in the cloud storage device 3 by sending a second request message to the data protection device 1 through the first network 2. The request module 101 receives from the user the second request message.

The data security module 103 then obtains the second data from the cloud device 3 through the second network 4 according to the second request message, and decrypts the obtained second data. In one example, if the second data was automatically encrypted using the first data encryption algorithm, the data security module 103 may decrypt the second data using a data decryption algorithm corresponding to the first data encryption algorithm. If the second data was encrypted using the second data encryption algorithm according to the encryption key, the data security module 103 must receive a decryption key from the user, and decrypt the second data according to the decryption key using a data decryption algorithm corresponding to the second data encryption algorithm. The decryption key may be the same as or different from the encryption key, which is determined according to the second data encryption algorithm used by the data security module 103.

The data processing module 102 further integrates the decrypted output from the second data according to the allotted numbers of the second data to recover or effectively recreate the first data required, and transmits the recovered data to the user through the first network 2. Thus, the first data stored in the cloud storage device 3 can be conveniently accessed by the user, and only by the user, through the data protection device 1.

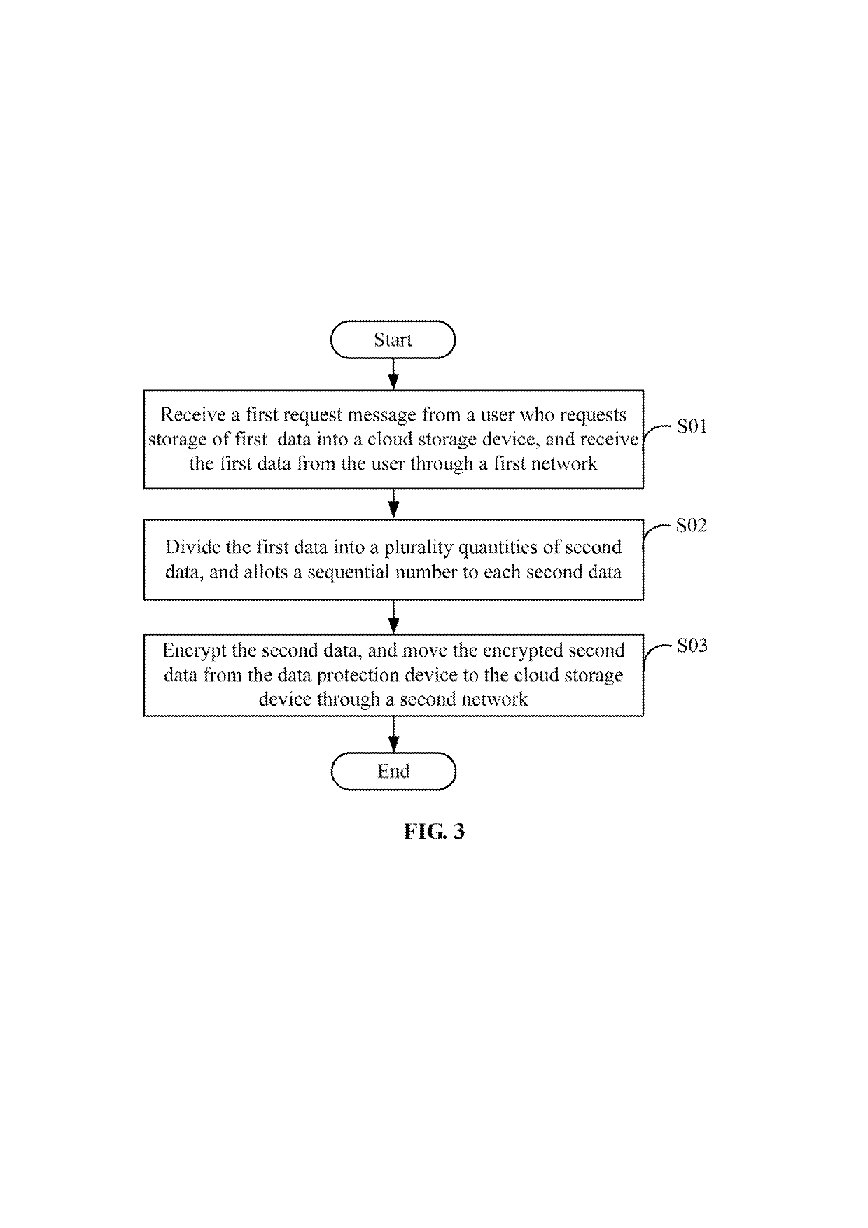

FIG. 3 is a flowchart of one embodiment of a data protection method implemented by the data protection device 1 for storing the data of the user. Depending on the embodiment, additional steps may be added, others removed, and the ordering of the steps may be changed.

In step S01, the request module 101 receives a first request message from a user that requests the storage of data (first data) into the cloud storage device 3, and receives the first data from the user through the first network 2.

In step S02, the data processing module 102 processes the received first data into the second data as hereinbefore described. The second data may be defined as data packets of the first data. In one example, the data processing module 102 may divide the first data using the information dispersal algorithm (IDA) as described above.

In step S03, the data security module 103 encrypts the second data in sequence, and moves the encrypted second data from the data protection device 1 to the cloud storage device 3 through the second network 4. Details of encryption of the second data are in paragraph [0013] hereof.

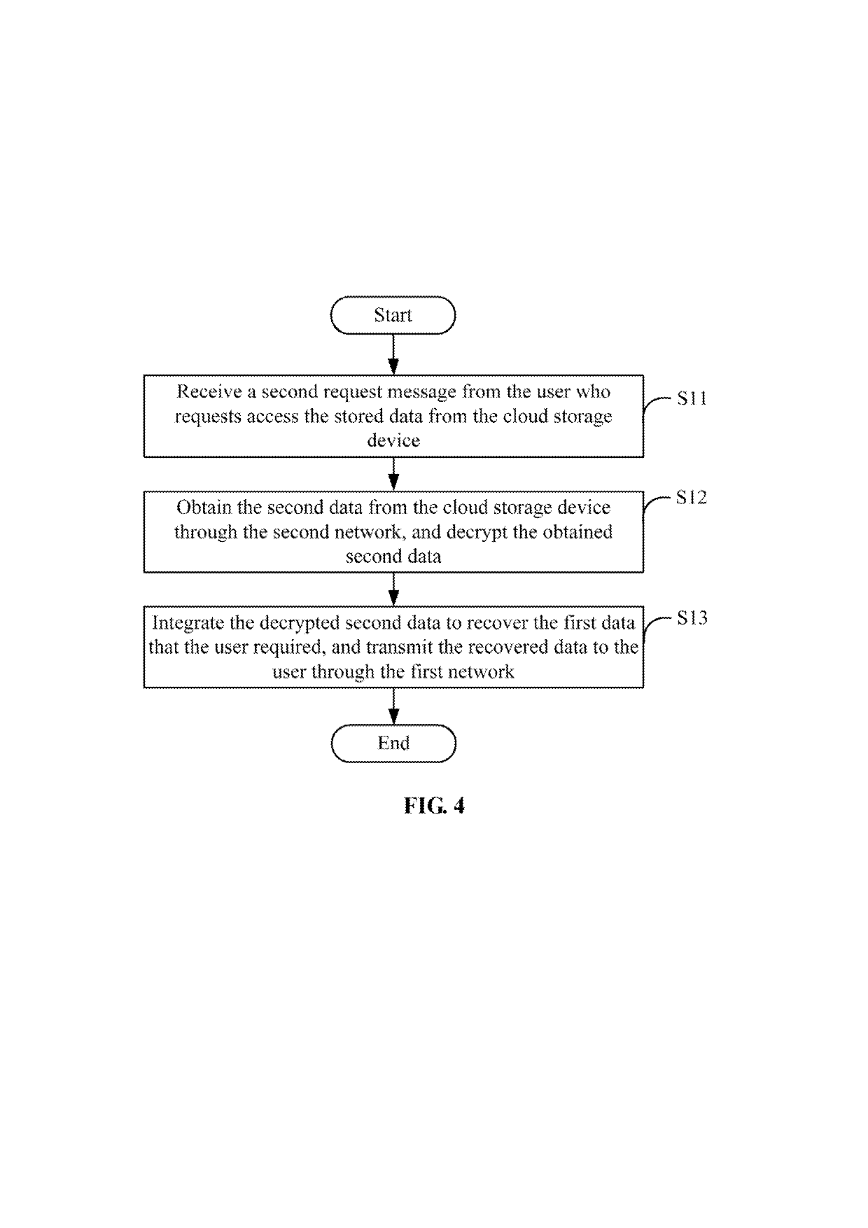

FIG. 4 is a flowchart of one embodiment of the data protection method that is implemented by the data protection device 1 when a request by the user is made to access the stored data from the cloud storage device 3.

In step S11, when the user wants to access the second data from the cloud storage device 3, the request module 101 receives the second request message requesting access of the second data.

In step S12, the data security module 103 obtains the second data from the cloud device 3 through the second network 4 according to the second request message, and decrypts the obtained second data. The decryption of the second data is described in paragraph [0015] hereof.

In step S13, the data processing module 102 integrates the decrypted output from the second data according to the allotted numbers of the second data to recover or effectively recreate the first data required by the user, and transmits the recovered data to the user through the first network 2.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A data protection method implemented by a data protection device, the data protection device communicating with at least one cloud storage device, the method comprising:
receiving a first request message from a user, and receiving first data from the user through a first network, the first request message requesting storage of the first data in the cloud storage device;
dividing the received first data into a plurality of second data, and allotting a sequential number to each second data; and
encrypting the second data in sequence according to the allotted number of each second data, and moving the encrypted second data from the data protection device to the cloud storage device through a second network.

2. The method according to claim 1, further comprising:
receiving a second request message from the user, the second request message requesting access of the second data from the cloud storage device;
obtaining the second data from the cloud device through the second network, and decrypting the obtained second data; and
integrating the decrypted second data according to the allotted number of each second data to recover the first data, and transmitting the recovered data to the user through the first network.

3. The method according to claim 2, wherein the encrypting step comprises:
encrypting the divided second data using a first data encryption algorithm; and

4. The method according to claim 3, wherein the decrypting step comprises:
decrypting the obtained second data using a data decryption algorithm corresponding to the first data encryption algorithm.

5. The method according to claim 2, wherein the encrypting step comprises:
receiving an encryption key from the user for encrypting the second data; and
encrypting the divided second data using a second data encryption algorithm according to the encryption key.

6. The method according to claim 5, wherein the decrypting step comprises:
receiving a decryption key from the user; and
decrypting the obtained second data according to the decryption key using a data decryption algorithm corresponding to the second data encryption algorithm.

7. The method according to claim 1, wherein the first data is divided using an information dispersal algorithm.

8. A data protection device in communication with at least one cloud storage device, the data protection device comprising:
a storage system;
at least one processor;
one or more programs stored in the storage system and executed by the at least one processor, the one or more programs comprising:
a request module that receives a first request message from a user, and receives first data from the user through a first network, the first request message requesting storage of the first data into the cloud storage device;
a data processing module that divides the received first data into a plurality of second data, and allots a sequential number to each second data; and
a data security module that encrypts the second data in sequence according to the allotted number of each second data, and moves the encrypted second data from the data protection device to the cloud storage device through a second network.

9. The data protection device according to claim 8, wherein the request module further receives a second request message from the user, the second request message requesting access of the second data from the cloud storage device, the data security module further obtains the second data from the cloud device through the second network, and decrypts the obtained second data, and the data processing module further integrates the decrypted second data to recover the first data, and transmits the recovered data to the user through the first network.

10. The data protection device according to claim 9, wherein the data security module encrypts the divided second data using a first data encryption algorithm.

11. The data protection device according to claim 10, wherein the data security module decrypts the obtained second data using a data decryption algorithm corresponding to the first data encryption algorithm.

12. The data protection device according to claim 9, wherein the data security module further receives an encryption key from the user for encrypting the second data, and encrypts the divided second data using a second data encryption algorithm according to the encryption key.

13. The data protection device according to claim 12, wherein the data security module further receives a decryption key from the user, and decrypts the obtained second data according to the decryption key using a data decryption algorithm corresponding to the second data encryption algorithm.

14. The data protection device according to claim 8, wherein the first data is divided using an information dispersal algorithm.
